(19) United States
(12) Patent Application Publication
(10) Pub. No.: US 2009/0086693 A1
(43) Pub. Date: Apr. 2, 2009

(54) System and method for RF space protection and control

(76) Inventor: Joseph P. Kennedy, Great Falls, VA (US)

Correspondence Address: DUANE MORRIS LLP, Suite 1000, 505 9th Street, N.W., Washington, DC, 20004, US

(21) Appl. No.: 12/213,950

(22) Filed: Jun. 26, 2008

Related U.S. Application Data
(60) Provisional application No. 60/937,084, filed on Jun. 26, 2007.

(51) Int. Cl. H04W 4/00; H04W 4/12

(52) U.S. Cl. 370/338; 455/466

(57) ABSTRACT

A system and method of controlling the operation of the wireless communications between a mobile device and access point by monitoring and modifying the communications.

The present application claims the priority of U.S. Provisional Application Ser. No. 60/937,084 filed Jun. 26, 2007, the disclosure of which is incorporated herein.

### BACKGROUND

This disclosure is generally directed to protecting and controlling the RF environment in and around selected physical infrastructure. The RF environment in and around infrastructure is becoming more and more useful for different purposes as wireless devices proliferate and become more capable. Examples of how the RF environment is being used include: detonating improvised explosive devices (IEDs), providing voice and data communications between individuals and groups, controlling utilities such as lighting and HVAC systems, product advertising, threat warning, etc. As mobile wireless devices continue to proliferate and become more capable, protection, monitoring and control of the RF environment in and around selected physical infrastructure (such as a building, shopping mall or oil field) will become as important as the current emphasis on physical and wired cyber protection, monitoring and control.

No current technologies or products/services exist to enable RF environment control and protection. There is prior art that forms part of the basis for the capability. Since mobile wireless services have been in use, first by the government and then later as a commercial service (i.e. cell phones), the issue of providing ubiquitous coverage has been a challenge. An area routinely plagued by poor coverage is indoors. To combat this problem, in-building coverage systems (a.k.a. repeaters) have been used. These repeaters have as their sole purpose to improve the performance of the mobile devices in the structure in question (building, sports complex, airport, etc.) Several manufacturers make these devices including Andrew Corporation, LGC Wireless, PowerWave, and Mobile Access. These repeaters can cover multiple RF bands (cellular, PCS, WiFi, 2-way radio), but do not broadly cover the RF spectrum, and only cover the portions of the spectrum where coverage enhancements are desired.

Mobile wireless devices, sometimes called portable devices, exchange signals with access points to first establish and maintain a communication link, sometimes referred to as control messages, and exchange signals to transfer communications between users of the mobile devices in the form of voice, data, short message service (SMS), a multimedia message service (MMS), etc., sometime referred to as traffic or user messages. In order to improve the propagation of the signals transmitted between a mobile device and an access point, sometimes a repeater system may be used which repeats the signals between the mobile device and the access point. For example, in the context of a mobile telephone system, a mobile telephone communicates with a base station as the access point. A common problem with mobile telephones is that when used indoors, e.g. in an office building, the mobile telephones sometimes have difficulty in receiving the signals transmitted by a base station, and vice versa. One solution to this problem is the deployment of a distributed antenna system throughout the office building. The distributed antenna may repeat the signals transmitted by the mobile telephone and the base station to improve the propagation of the communication signals.

Another existing capability is geolocation systems for wireless mobile devices. Much of this work was catalyzed by the US government FCC mandates for locating wireless 911 calls. Companies that provide these systems include Qualcomm, Andrew Corporation, Ericsson and TruePosition. These systems provide location for mobile devices both outdoors and indoors through a variety of means (handset based and network based), but are not oriented towards working across broad spectrum and have no specific purposes towards RF environment control and protection.

Another existing technology related to this invention is RF signal jamming. Devices that perform this function are generally not sophisticated and have as their purpose the denial of service in a particular RF band, and in a particular geographic area. Companies that make these devices include General Dynamic and Homeland Security Strategies. An example of this technology is the jamming devices being used by the military in Iraq to mitigate the use of RF devices to set off roadside bombs.

None of these technologies individually or as unimproved combinations can supply the functionality envisioned by the present disclosure.

### SUMMARY

The present disclosure has an analogous purpose to physical security and surveillance. Physical barriers (like concrete or steel plates or walls, and manned egress points) are used to keep unwanted individuals or materials away from or outside of buildings or zones. Surveillance cameras are used to monitor egress points or critical areas in buildings or zones to detect suspect activity. The present disclosure also had an analogous purpose to cyber security and surveillance. Firewalls are used to detect and deny communications with unknown, suspicious or nefarious network elements (i.e. internet). Virus and spyware protection software attempts to detect and defeat malicious programs. Likewise, the present disclosure provides boundaries for use, control and monitoring in the RF environment.

The present disclosure has utility in both government and commercial applications. Some typical applications illustrate the utility. Security applications include: RF IED detonation prevention, RF device detection within the space, detecting signals directed at devices in the space, deny service to non-authorized users, finding suspects in/around the space, and detecting/blocking communications out of protected space (pictures/video). Infrastructure/space where these features may be useful include: government buildings, freight trains, warehouses, refineries, chemical plants, factories, power plants, bridges, oil and gas fields, reservoirs, and agricultural areas.

In a commercial environment, an alternate set of applications may be enabled with this disclosure. They include: paid subscription-only access, restrict access to some class of users, mobile advertising, control for cell phone access on cruise ships, service only for teachers in high schools or for students only between classes/after school, accessible areas in hospitals (unrestricted area denial), no service during performances in theaters, child tracking in malls or for the child care service in mall, and service denial during religious services. Infrastructure/space where these features may be useful include: sports arenas, airports, airplanes, busses, passenger trains, tunnels, gas stations, ferries, theaters, and shopping malls.

RF environment control is not limited to cell phones. Services such as 2 way radio, WiFi, and wireless remote control (toys, garage doors) are all candidates for monitoring and control. Of course, an aspect of the present disclosure is to enable emergency calls in all of these scenarios.

### SUMMARY OF THE DRAWINGS

FIG. 1 is a simplified pictorial representation of RF environment control in an around a physical space.

FIG. 2 is a simplified pictorial representation of providing RF control using distributed equipment in a building.

FIG. 3 is a simplified block diagram of the functions of one embodiment of the present disclosure.

FIG. 4 is a simplified block diagram of the functions of one embodiment of the present disclosure.

FIG. 5 is a simplified block diagram of the functions of one embodiment of the present disclosure.

FIG. 6 is a simplified block diagram of the functions of one embodiment of the present disclosure.

### DETAILED DESCRIPTION

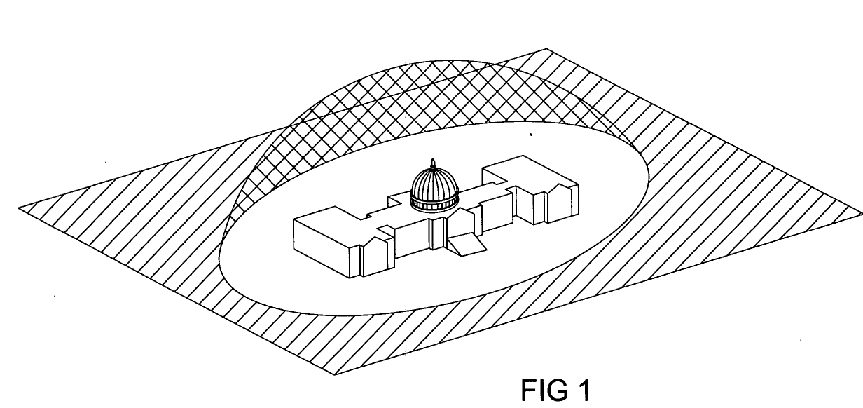

One concept of RF environment control is illustrated in FIG. 1. It can be thought of as placing a dome around a structure where the use of the RF environment (the propagation of electromagnetic waves) is monitored and controlled. The high level monitor and control applications are accomplished by introducing new functions into an RF coverage system for the space. The new functions may include:

Ability to monitor forward and reverse link control and user data
Ability to blank and insert messages into links
Ability to geolocate users in the space
Ability to monitor broad ranges of spectrum of interest at distributed antennas and compare results
Ability to selectively (time, location, power) emit RF noise into the space through distributed antennas.
   These functions allow monitoring and control for a comprehensive group of RF spectrum users including:
External networks (two way signaling to points outside of the space including cellular, PCS, 2 way radio, WiFi, etc.)
Internal networks (two way signaling to points inside of the space including WiFi, cordless phones, 2 way radio)
Remote control (one way signaling external to internal, internal to external, internal to internal including garage door openers, remote control toys, keyless car remotes, etc.).

At a high level, these functions allow the following capabilities with respect to radio transceivers in and around the space:
Detect
Locate
Identify
Determine patterns of use
Determine communication source/recipient identity
Control access (by location, service, user, and band)
Selectively communicate at will (by location, service, user, and band).

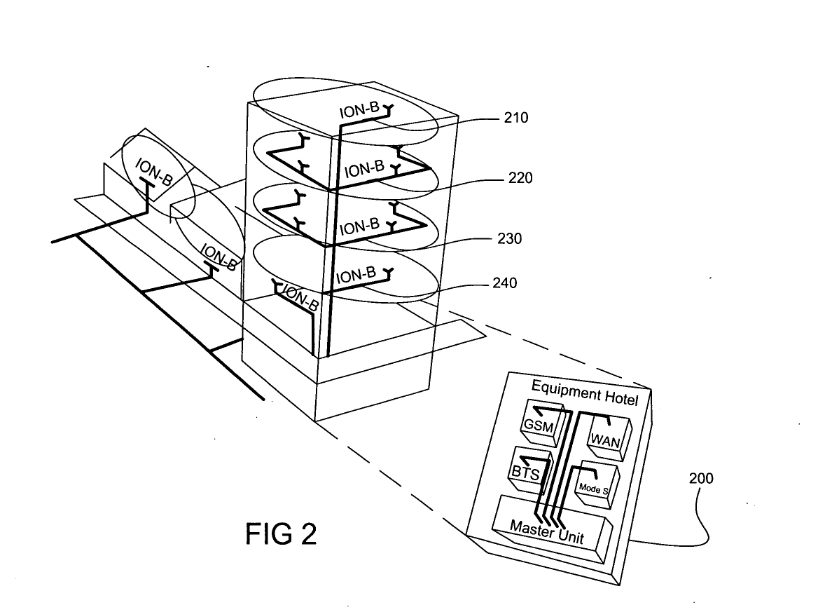

A starting point to creating this capability is to install a set of distributed antennas in the space in an analogous way to how an in-building/repeater coverage system is installed. FIG. 2 illustrates a prior art method of providing in building RF coverage. In general, two subsets of equipment are used to provide in-building coverage. The “head end” equipment 200 (referred to as the Master Unit in the Equipment Hotel in FIG. 2) serves the purpose of connecting to the external or internal wireless network, either through a base station in the space or remotely via a donor antenna oriented to receive/transmit signals to a base station that serves the area. Other local base station connections or donor antenna installations can be used to provide service for multiple wireless services (i.e. Verizon, Sprint, AT&T, etc.). The other group of equipment is referred to as remote units 210-240 (designated by the Andrew product name ION-B.) The remote units 210-240 are composed of antenna and transceiver assemblies, and provide the RF coverage in the vicinity of their installed location. The remote units 210-240 are connected to the head units 200 via RF or fiber optic cable. Forward and reverse link transmissions are carried to and from mobile RF devices being served by the remote 210-240 units through the master unit 200 to other network nodes. This general architecture allows coverage enhancements to be provided in the space, but not RF environment monitoring and control. RF monitoring and control as described in the present disclosure are enabled with additions to the basis distributed antenna architecture.

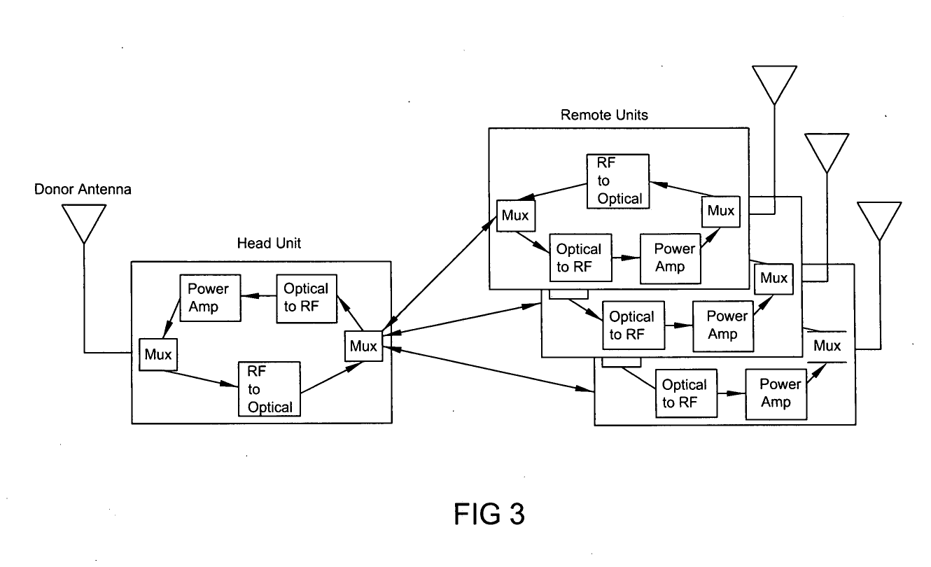

FIG. 3 provides a high level block diagram of the major functions in the prior art in-building RF coverage system of FIG. 2. This example uses fiber backhaul, but the same basic architecture applies to RF interconnected versions. As is apparent from FIG. 3, the function of this device is to carry RF energy to and from the remote antennas for distributed coverage.

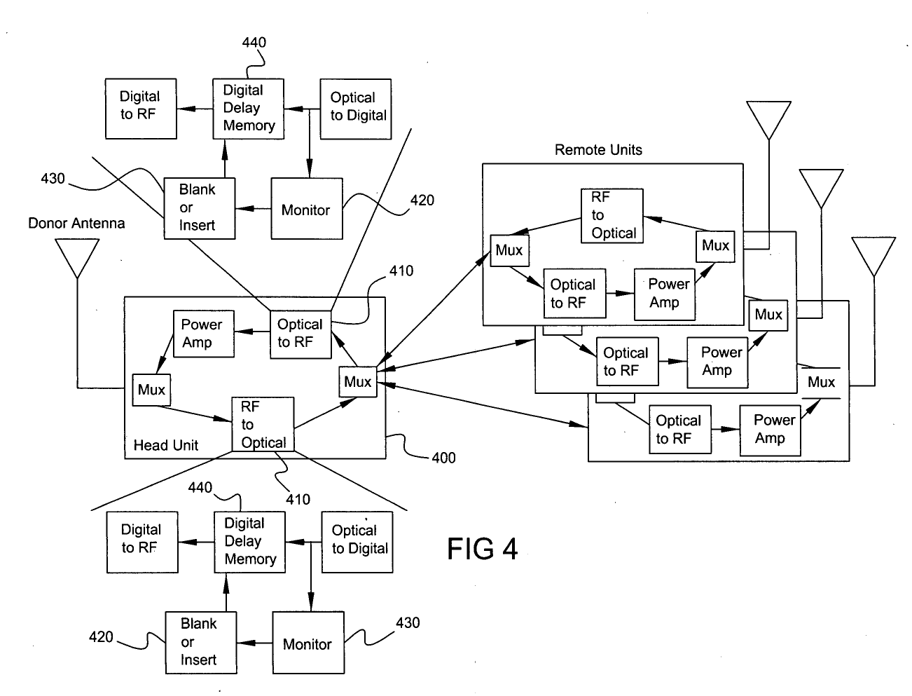

FIG. 4 illustrates an embodiment of the present which allows RF monitoring and control. Monitoring can include creating connections to or around the distributed antenna system to access a forward link wireless signal from the access point to the mobile device and a reverse link wireless signal from a mobile device to the access point, receiving, synchronizing and making measurements on these signals, and decoding, identifying and determining the content and information in these signals. Two functions can be added to the basic in-building coverage system to enable monitoring and control. In the head end unit 400, data is converted to/from optical to RF 410 to enable transport to/from the remote units. If this conversion function is done using an intermediate step which converts the RF or optical to digital electrical samples, then the control and user data that is being sent over the communications channels (both forward and reverse link) can be monitored 420. Such data can include the identity of users, phone numbers being called, the identity of the handsets, etc. This information can provide valuable insight into the persons who are using the communications services in the space. Another function can be added that allows the use of the communications systems to be controlled. This function is called “Blank or Insert” 430 in FIG. 4. Based on the monitoring functions 420, the digitized RF in the digital delay block can be modified in ether link direction to accomplish a particular control goal. For example, if service denial to a particular user is desired, messages on the control channels addressed to that user can be blanked as they pass through the digital delay 440. Alternately, a message could be inserted into a channel requesting that a particular handset identify itself so that authorities can learn if its owner is resident in the space. Cross forward to reverse (and reverse to forward) link control is also possible and desirable for any communication information, whether a control message or a user message. For example, a message could be detected on the reverse link by the monitoring function for a service request from a suspect handset. A message could be inserted on the forward link in place of a message from the external wireless system instructing the phone to shut down to permanently deny service to that device. This might be useful if the owner of the phone was suspected of taking surveillance photos in a sensitive facility. Another service enabled with these additions is the ability to selective or broadly alert mobile users via SMS or even voice message. With the ability to insert messages, the network can control content delivery virtually at will. Given that the network can have complete control over the mobile uplink and downlink messages, it could replace the external wireless network, and even initiate dedicated circuit switched calls. It could also manipulate bit errors and control functions to enable and disable any encryption to allow unimpeded message modification. With the ability to detect call setup types through the monitoring functions, emergency calls can always be permitted to connect.

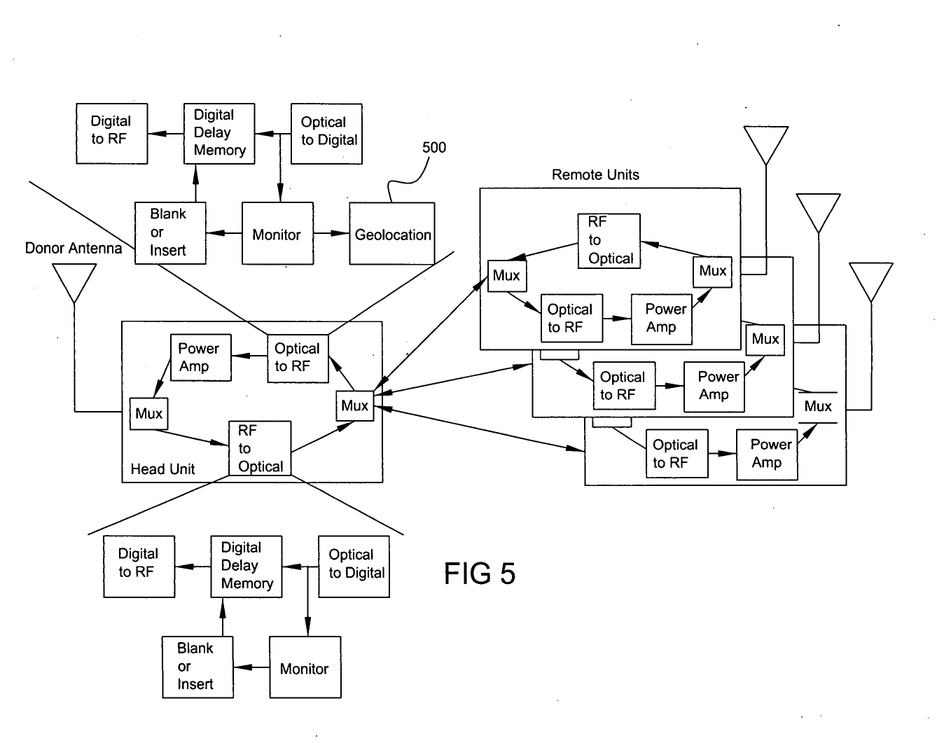

With reference to FIG. 5, geolocation functionality 500 can be added to provide comprehensive monitoring and control is added. Based on either network (serving antenna, uplink power (propagation model or radio fingerprinting), uplink time of arrival/time difference of arrival, angle of arrival) or handset (AGPS measurements or calculated location) measurements, the location of the handsets being served by the distributed antenna system for the space can be located. The requisite data is accessible in the uplink control or user data through the monitoring function. All of these location methods are known; the novelty is the application to a controlled space, the access method for the measurements, and the association of the measurements with other data to perform the monitoring and control functions. For example, a distributed antenna that receives an uplink transmission form the mobile device can measure a characteristic of the signal, i.e., AOA, TDOA, TOA, power level, etc., and use this characteristic alone, or combined with other information, e.g., measured characteristics from other distributed antennas, to determine the location of the mobile device. The computation of the location need not be determined at the distributed antenna, but can be accomplished at a remote location, which receives information form other distributed antennas as well. With the addition of this functionality, many new services are possible. If the space in question is a shopping mall, mobile coupons can now be directed a specific shopper who are in or close to a store. Also, suspicious activity related to location can be identified. For example, if a mobile phone remains stationary for days with only incoming calls, it could indicate a lost phone or a triggering device for a bomb.

Many options and features with respect to commercial and government applications are made possible. Returning to the mobile coupon in the mall example, coupon delivery can be conditioned on many variables. Geo-fences (polygon regions defined in and around the mall) can be devised whereby entry into a geo-fenced area can trigger a coupon delivery. Different types of coupons can be delivered depending on how long the phone has been in the mall, or the current time (food coupons near meal times). Coupons/notices could also be delivered upon exit from a geo-fenced area. Post facto combining of geolocation data with other consumer information such as merchandise purchase records could also be useful to merchants in understanding buying habits and coupon delivery/content effectiveness.

With respect to government/security applications, geo-fenced areas can be defined around mall HVAC equipment, and authorities could be notified if phone users strayed or stayed near these areas. Notices could be sent to these phones informing the owners to vacate the area. Security measures could also be triggered based on phone calling patterns. For example, if a phone dials 911 or some other emergency number (detectable in the monitoring function), mall/building security personnel could be immediately dispatched to the location of the dialing phone.

In general, coupons/notifications/actions can be triggered on current location, location over time, current time, incoming/outgoing calls/messages, calling/message patterns and combinations.

Additionally, locations generated via the control and monitor system could be inserted into messages used by the standard commercial wireless network to improve location performance indoors. Indoor location performance has been a challenge using standard methods, especially AGPS-based location.

For certain classes of mobile communication services such as cell phones, alternative means can be used to achieve some of the described functionality. For example, an alternative means to deliver an advertisement based on a mobile device moving into a geo-fenced area would be to send the advertisement via a short message (SMS or short message service) using standards based methods supported by the commercial network. In the case of GSM service, messages could be sent from the head unit addressed to the desired mobile through the SMSC (short message service center).

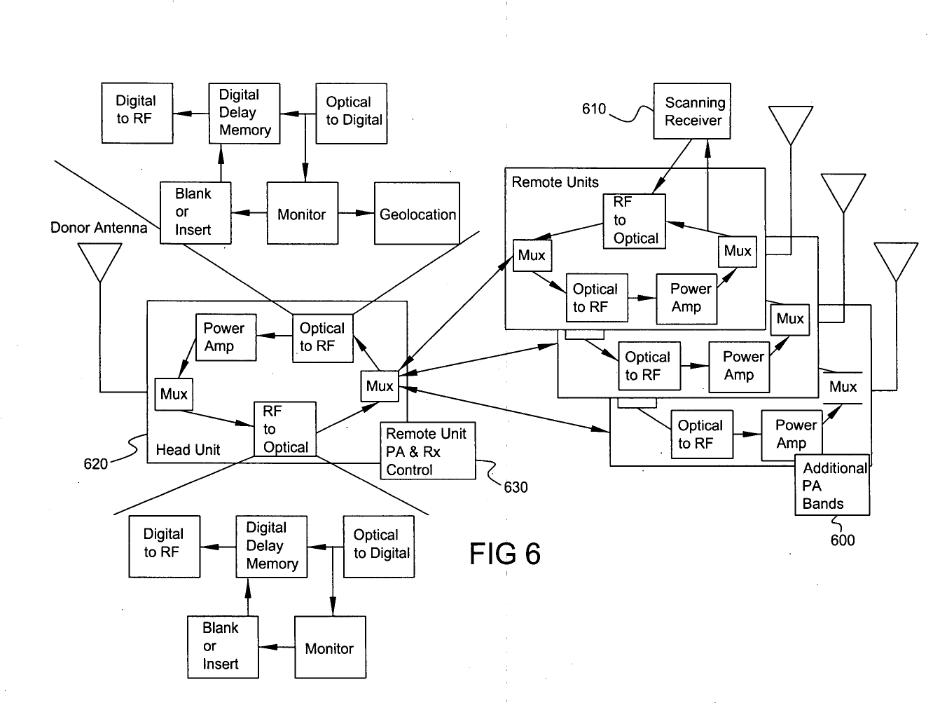

The features described so far address RF spectrum users that can be characterized as having forward and reverse links communicating through an external network with generally external to the space users. Another variety of RF spectrum users of interest are ones that transmit in one direction from a control device to controlled device (control services). Examples of these users are keyless entry transmitters/receivers, radio control toy transmitters/receivers and garage door opener transmitters/receivers. These control services devices can be used for nefarious purposes, and are therefore important to monitor and control. FIG. 6 illustrates additional functionality that can be added to address these control service devices. At the remote units, additional RF band power amps 600 can be added to provide the ability to inject noise into the bands where these devices operate. With the addition of this close proximity noise power, a controlling device outside the space will have difficulty being received. Also at the remote units, a scanning receiver 610 can be added (the function could also be added at the head subsystem with spectrum from each remote antenna transferred over the fiber links). These receivers 610 can be used to scan the RF environment for controlling devices, or controlled devices where unintended emission (such as local oscillators) may be detected. Results from the scanning receiver scans can be sent to the Head Unit 620 via the fiber link. A new management function (referred to as PA & RX control 630 in the figure) is added to the Head End equipment to allow the power amplifiers to be turned off and on with selected power levels so that the scanning receivers can be used for device detection. A typical scenario for using the scanning receivers 610 would be to infrequently turn off the power amplifiers for a short period of time to scan for control device energy. By using scan information from different distributed antennas (including optionally externally mounted antennas), spectral energy outside of the local remote antenna coverage area can be “subtracted” from the energy detected to arrive a an estimate of the RF energy that is emanating from the relative small coverage area.

It may be emphasized that the above-described embodiments, particularly any “preferred” embodiments, are merely possible examples of implementations, merely set forth for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure and the present disclosure and protected by the following claims.

What is claimed:

1. In a wireless communication network having a mobile device which communicates with an access point and having a repeater system comprised of at least one distributed antennas to extend the coverage of the wireless signals transmitted between the mobile device and the access point, a method comprising:
(a) at, through or in association with a distributed antenna, receiving a first RF communication signal;
(b) converting the first RF communication signal to a digital signal;
(c) monitoring the converted digital signal to retrieve communication information;
(d) controlling the operation of the mobile device as a function of the retrieved communication information.

2. The method of claim 1 wherein the first communication signal is a control message from a base station to a mobile telephone.

3. The method of claim 1 wherein the first communication signal is a control message from a mobile telephone to a base station.

4. The method of claim 1 wherein the first communication signal is a user message from a mobile device to an access point

5. The method of claim 1 wherein the first communication signal is a user message from an access point to a mobile device.

6. The method of claim 2 wherein the retrieved communication information is one of identity of the mobile device, location of the mobile device, identity of the mobile device user, configuration or status of the mobile device, configuration or status of the base station, configuration or status of the wireless network, measurements on the wireless network signals made at the mobile devices, measurements on the wireless network signals made at the base stations, and content of the message transmitted

7. The method of claim 6 wherein the step of controlling includes denying service to the mobile device.

8. The method of claim 6 wherein the step of controlling includes permitting or inducing a specific type of communication.

9. The method of claim 8 wherein the specific type of communication includes one of control message, user message, short message service (SMS), control, and a multimedia message service (MMS).

10. The method of claim 1 wherein the step of monitoring includes
(i) creating connections to or around the distributed antenna system to access a forward link wireless signal from the access point to the mobile device or a reverse link wireless signal from a mobile device to the access point,
(ii) synchronizing with the forward link or reverse link signals, and
(iii) determining the content in the synchronized signals

11. The method of claim 2 wherein the step of controlling further comprises the steps of:
(i) creating a second RF signal based on the received first RF signal; and
(ii) transmitting the second RF signal to the mobile device.

12. The method of claim 11 wherein the step of creating includes inserting a message into the second RF signal

13. The method of claim 12 wherein the second RF message is one of a control message, a user message, an SMS, or a multimedia message service (MMS).

14. The method of claim 12 wherein the second RF message instructs the mobile device to shutdown.

15. The method of claim 12 wherein the second RF message instructs the mobile device to transmit an identification signal.

16. The method of claim 11 wherein the step of creating includes blanking a portion of the first digital signal.

17. The method of claim 4 wherein the step of controlling further comprises the steps of:
(i) creating a second RF signal based on the received first RF signal; and
(ii) transmitting the second RF signal to the access point.

18. The method of claim 17 wherein the step of creating includes inserting a message into the second RF signal

19. The method of claim 18 wherein the second RF message is one of a control message, a user message, an SMS, or a multimedia message service (MMS).

20. The method of claim 1 further comprising the step of measuring a characteristic of the first received signal.

21. The method of claim 20 further comprising the step of determining the location of the mobile device at least partially based on the measured characteristic.
